(19) United States
(12) Patent Application Publication
(10) Pub. No.: US 2012/0033066 A1
(43) Pub. Date: Feb. 9, 2012

(54) Method and device for optically measuring the surface of a product

(75) Inventor: Roman Franz Wieser, Hovorcovice (CZ)

(73) Assignee: WITRINS S.R.O., Hovorcovice (CZ)

(21) Appl. No.: 13/201,808

(22) PCT Filed: Mar. 2, 2010
(86) PCT No.: PCT/IB2010/000944

§ 371 Date: Oct. 25, 2011

(30) Foreign Application Priority Data
Mar. 3, 2009 (CZ) 2009-133
Aug. 27, 2009 (EP) 09466016.4

(51) Int. Cl. H04N 7/18; G01B 11/00

(52) U.S. Cl. 348/87; 356/326; 348/E07.085

(57) ABSTRACT

The present invention relates to a device (10), a method and an application thereof for optically measuring the surface of a tested product (5), especially a PCB-product for reflow soldering paste inspection. The device comprises at least one white light source (1) for emitting a beam of white light, at least one collimation unit (4) for collimating said beam of white light (30), at least one spectrometer unit, preferably an optical prism (2) or an optical diffraction grading (51), for splitting said beam of white light (30) into a beam of multichromatic light (31) being directed onto said tested product (5) under a predetermined incident angle γ, and at least one camera (3) for recording a reflected beam of monochromatic light (32) of said tested product (5). Z-axis surface height information of said tested product (5) can be extracted from a hue value of said reflected beam of mono chromatic light (32) while relatively moving said tested product (5) in a x-axis scanning direction (9).

### FIELD OF THE INVENTION

The present invention in general relates to a device and a method for measuring and inspecting a distance between a sensor and a product under testing. In particular, it can be used in the field of electronics for the measurement and testing of the position of the components mounted on printed circuit boards (PCBs) or on a solar cell product or for inspecting the position of connectors of electronic components, such as ICs, capacitors, transistors, resistors etc., or the position of reflow soldering paste prior to mounting electronic components on a PCB for reflow soldering. The present invention is preferably applicable to the production of PCBs, solar cell products such as solar cell wafers or solar cell elements and other items that require a measurement of flatness in order to thusly specify their quality and can also be used for testing the surface roughness of product surfaces. The present invention can also be used for inspecting a three-dimensional form of various items when recording an image without the necessity of performing scanning operations from several positions, which is particularly advantageous in high-production processes, i.e. in processes where testing of the surface roughness and defects etc. is required.

### BACKGROUND OF THE INVENTION

From the state of the art such surface height measurements are most frequently performed with the aid of a line laser and a high-speed camera, preferably using a laser triangulation technique. The line laser is directed to the measured surface and the camera, which is directed below the specified angle, records the profile of the measured area in one coordinate (in one place) so that the laser lights it up. The individual images are recorded with the frequency corresponding to the width of the laser beam and all images are then composed. Using this procedure, it is possible to compose a 3D model. Another method is the use of several cameras which are directed to the tested area from various angles. From the known trigonometry of the camera inside the tester, a 3D model can be composed.

A further method is the use of the Moiré effect by means of which, under certain circumstances, it is possible to make the relief of the tested area visible. Images are produced through two line grids, always with inverse brightness. After composition of both images, when using the interference effect, the relief of the surface is reflected.

The methods known from the state of the art do not allow for obtaining surface height information with a precision of less than +/−20 μm. Furthermore, a maximal scanning width of a measured product is limited, making it infeasible to scan products being wider than 150 mm. The scanning speed is limited thus making surface measurement to a bottle neck of a high speed production process.

It is consequently an object of the present invention to provide a method and a device for measuring and inspecting a surface of a product with high precision, high speed, variable measurement resolution and with an increased γ width. Furthermore, it is an object of the present invention to provide a method and a device being capable of performing a self-calibration, thus eliminating high-precision structural construction and complicated calibration efforts.

The above-mentioned problems of the state of the art are solved by a device and a method according to the independent claims. Advantageous embodiments are the subject-matter of the dependent claims.

### SUMMARY OF THE INVENTION

The present invention provides a device for optically measuring the surface of a tested product, which enables performing an inspection of the surface of a product, a component alignment inspection or an inspection of soldering paste arrangement prior to a reflow soldering process, and which enables a creation of an optical 3D model of the product surface. The device comprises the following components:
a white light source, advantageously emitting a white light beam with a continuous spectrum. The light is rectified by a collimation unit including optical means, such as lenses, aperture means etc., into a parallel, narrow and collimated beam which then passes through a spectrometer unit, preferably an optical prism or an diffraction grading. Preferably, the aperture means comprises a slit diaphragm for producing a flat and broad expanded beam of white light.
a spectrometer unit, especially an optical prism, mediating a decomposition of the white light into a multichromatic light beam comprising a broad frequency spectrum of light. The multichromatic light entering the prism contains selected or all colour components of the white light. After passing through the spectrometer unit, the white light disintegrates into individual colours according to the law of light refraction. The individual components are monochromatic having different hue values, whereby the multichromatic beam comprises a spectrum being spatially distributed and illuminating a surface of a product under testing in a scanning direction. The width of this spectrum directly influences the measuring precision of a z-axis height of the product surface.
a camera, preferably a line scanning camera. The camera gradually records the tested surface line by line while the product under testing is moved relative to the camera in a x-axis scanning direction. The geometric position of the camera and the light source, while recording the whole time, remains the same. The camera and the light are adjusted to zero height line by line (ground) so that the camera displays the beginning of the spectrum, i.e. the red colour. All non-zero heights are then displayed in another colour as they are in the colour spectrum. Thereby it should be pointed out that either the product under test is moved relative to white light source, spectrometer unit and camera, or white light source, spectrometer unit and camera are relatively moved with respect to the product under test.

In other words, the device for optically measuring the surface of a tested product, especially for inspecting a PCB-product for reflow soldering paste inspection, comprises at least one white light source for emitting a beam of white light, at least one collimation unit for collimating said beam of white light, at least one spectrometer unit, preferably an optical prism or an optical diffraction grading for splitting said beam of white light into a beam of multichromatic light being directed onto said tested product under a predetermined incident angle γ, and at least one camera for recording a reflected beam of monochromatic light of said tested product. In this way, a z-axis surface height information of said tested product can be extracted from a hue value of said reflected beam of monochromatic light while relatively moving said tested product in a x-axis scanning direction.

The collimation unit can preferably collimate the light at least to a collimation quality of 2° or less in all directions. In contrast to parallel light, collimated light creates highly-parallelized light beams of all colours/hue values. The collimation unit can comprise optical rectifying means, such as lenses, apertures or mirrors, to collimate the light in 360°. From the collimated light a multichromatic spectral line of light is formed by the spectrometer unit, wherein the individual colours/hue values are represented in such a manner so as to be distinguishable from one another. For directing said light, a light mixing means, e.g. an aperture or a fibre, can be used.

According to an advantageous embodiment, said white light source can have a continuous spectrum. Alternatively or additionally, the frequency-bandwidth of the spectrum can be variable, preferably in a wavelength range of 350-850 nm (ultraviolet to infrared). Alternatively or additionally, the intensity of the white light source can be adjustable, preferably by dimming of said light source or by selectively switching two or more light sources on or off in parallel.

According to another favourable embodiment of the invention, an ensemble of a white light source, a collimation unit and a spectrometer unit can be represented by an LCD-projector, a video projector or another video imaging device being capable of producing a beam of multicoloured light. As such a projector usually comprises a white light beam, a collimation unit for rectifying and collimating said beam of white light and a spectrometer unit, for instance an multicolour-LCD for converting said beam of white light to a beam of multicoloured light. Usually specifications of a multichromatic beam of light, such as brightness, opening angle, width of different parts of said coloured beam etc, produced by an LCD-projector can easily be controlled by an image control unit for producing a multichromatic beam of light with different colour-width resolution such that a measurement accuracy can easily be controlled. Furtheremore such LCD-projector is capable of producing 100 fps (frames per second) or even more for adaptively changing the shape of the beam. A projector can easily be combined with an area- or a line scanning camera for providing an embodiment of the invention.

According to another advantageous embodiment, said white light source can be adapted for producing a white light stripbeam. Alternatively or additionally, said light source can be a LED light source, preferably a LED stripe, wherein at least one microlens can be optically coupled to at least one LED for pre-rectification of said beam of white light. Alternatively or additionally, multiple LEDs of a LED stripe can be selectively switched either on or off for enhancing intensity and/or length of a white light beam in a y-axis direction perpendicular to said scanning direction. Alternatively or additionally, a LED stripe can comprise multiple differently coloured LEDs for mixing multi-coloured light to a white light beam for providing an adjustable frequency spectrum of said white light beam. Preferably, said LED stripe comprises one or more LEDs. LEDs produce a non-collimated light which radiates in all directions, thus the radiation of the light has to be pre-rectified according to the structure of the LED stripe.

Said light stripe can be adapted to a desired scanning width such that the device can inspect products with different y-axis widths. Favourably the light stripe can have a width of a maximal scanning width, whereby said “long” beam of white light can be adaptively focused to a “short” beam of white light by a parallax free optic. For instance such a light stripe can have a length of 450-600 mm in y-axis direction and the length of said flat beam of white light can be focused by a parallax free optic to a length of 150 mm. The z height resolution can be adapted by a variable aperture width, spectrometric angle of said spectrometer unit or distance of spectrometer unit from the surface. Due to the variability of z height resolution, different scanning resolutions can be achieved. The y-width of the light stripe can be enlarged by using mirrors, light guiding elements, such as fibres, or lenses etc.

A light stripe can also be produced from a punctual light source by use of an objective and/or a cylinder lens. Thereby, the choice of different glasses can adjust different refraction indices and can enhance a parallax-free image.

LEDs often produce inhomogeneously distributed white light. Therefore, it can be advantageous to mix different kinds of white or multi-coloured LEDs for producing a homogeneous white light spectrum. Such a mixture can be achieved by using lenses, mirrors, glass fibre optics or the like. Furthermore, several light stripes can be used in parallel for the addition of light beams in order to enhance scanning velocity.

The quality of the white light can be further enhanced by integrating a polarising filter element into the white light source for reducing reflection effects and is especially advantageous for illuminating metallic/non-metallic surfaces. In conclusion, the quality of the white light can be enhanced by:
variable aperture size;
spectral homogeneity of the white light beam;
parallax-free light for reducing shadowing effects;
optical means for adapting light stripe length to aperture length in y-direction;
light intensity control means for adjusting surface reflection effects;
adaptable light stripe length for adapting scanning width to product dimensions.

According to another advantageous embodiment said collimation unit can be adapted to collimate said white light beam in 360° and can be adapted to form a white light strip-beam being perpendicular to said scanning direction and can preferably comprise at least one lens and/or a collimation grid and/or at least one aperture means, preferably an adjustable slit diaphragm aperture means.

According to another advantageous embodiment, said device can also comprise a scanning transportation means for relatively transporting said tested product or said light source, spectrometer unit, collimation unit and camera in a scanning direction.

According to another advantageous embodiment said camera can be a line scanning camera, preferably comprising a camera aperture unit and/or a parallax lens unit for reducing parallax effects, especially a cylinder lens or a round lens unit, for receiving a beam of monochromatic light reflected from said beam of multichromatic light by said tested product. Alternatively or additionally, said camera can be a digital camera with at least 8 Bit hue resolution, preferably an adjustable 10, 12 Bit or higher hue resolution. Alternatively or additionally, said camera can comprise two or more line scanning rows, each row comprising a colour filter for increasing hue sensitivity. Alternatively or additionally, said camera can comprise at least one grey or black/white scanning row for enhancing scanning quality. Alternatively, said camera can be an area scanning camera, whereby single or multiple scanning rows of said scanning area can be extracted for hue height information processing. Such an area camera can preferably have 1500 rows or more and can be used for resolutions down to 20 μm. Advantageously the camera comprises two or more scanning lines with different colour filter elements in front of said two or more scanning lines enhancing sensitivity of each scanning line to different hue values by said different colour filter elements.

Due to a large y scanning width of a camera perpendicular to a x-axis scanning movement direction, a scanned image can comprise parallax-related errors. Using parallax lenses in a line of sight between product surface and camera but also between white light source and spectrometer unit, allows for correcting parallax errors, thus enabling a 3D scan of a product without high quality. A parallax lens system is supposed to correct different light diffraction characteristics of all wavelengths. The lens system can comprise length-extended cylinder lenses but also round lenses. Cylinder lenses can be advantageous when using a line scanning camera.

The degree of z height resolution is a result of a combination of reflected hue values of the spectral light and colour resolution accuracy of said camera. CCDs or other digital cameras usually can provide 8-10 Bit colour resolution per pixel. Adjusting colour resolution of the camera can increase measurement resolution. Use of different numbers of camera lines for scanning can be another possibility of scaling measurement resolution. For instance a two line camera can be used and the camera can focus on two or more different colour areas such that a scalable resolution can be achieved. The number of camera lines can also be increased to four or even more scanning lines, whereby different colour filters can be assigned to individual camera line rows, thus enhancing resolution accuracy.

Use of an area camera or multiple line cameras being capable of scanning a surface area of the tested product instead of a line camera scanning a y-axis surface line perpendicular to a x-axis scanning movement direction can also be advantageously used as a scanning camera. Individual lines of the image produced by the surface area can be extracted as multiple scanning rows, whereby an increasing number of extracted rows can increase the measurement accuracy. Furthermore, a scanning speed can be increased by extracting multiple scanning rows at once.

A camera can comprise one or more colour-sensitive scanning rows and at least one black/white or grey scanning row. As such, the black/white or grey scanning row can scan a 2D image of the product surface for providing x/y dimensions of the product. The colour scanning row provides hue information of the z height of the product surface such that in one scanning process x/y and z dimension values of the product can be extracted. Especially if a surface of a product is full of fissures, a 2D image provides exact x/y dimensions for associating z data to distinct surface areas of the product.

It can be advantageous to use a camera comprising a processing unit for directly converting hue values to z height values based on calibration data of a hue height map. Thus, the camera's processing unit can directly convert camera RAW data into z height data which can be transmitted to a control unit. Furthermore, said processing unit can use different calibration routines, such as extraction of brightness, conversion of RGB in HSI data (Hue, Saturation, Intensity), geometric calibration based on row data capturing and row shift calculation etc.. Thus, the camera is capable of directly outputting z height measurement data, whereby the camera can provide 3D area data of the scanned product.

According to another advantageous embodiment at least two or more cameras can be arranged in a y-axis direction perpendicular to said x scanning direction for parallel scanning, thus enhancing scanning width of said product. Alternatively or additionally, said two or more cameras can be stereometrically arranged for 3D scanning of said product for reducing shadowing and illumination effects. Arranging two or even more cameras in one scanning row perpendicular to a scanning direction can increase scanning width, thus enabling a scanning of large products with high speed. Using a stereometric arrangement of two or more cameras focusing on a certain line or on the product surface can decrease shadowing effects which can thusly increase measurement accuracy.

According to another advantageous embodiment said device can further comprise a control unit in electrical connection with at least said camera, said control unit can comprise control means and hue height mapping means adapted to at least control said camera and to map hue values of an image captured by said camera in order to obtain surface height information of said product.

According to another advantageous embodiment said device can further comprise adjustment means which can be controlled by said control means of said control unit for adjusting the colour spectrum width d of said multichromatic beam, particularly for adjusting an armature width w of said collimation unit, and/or for adjusting a beam splitting height b, a distance a between optical line of source and camera or said prism angle a of said spectrometer unit for adjusting height measuring sensitivity.

The measurement method of the tested product comprises the following steps of:
calibrating the colour scale for [mm] of the height. This is performed by scanning the declination of the area where the angle of declination is known in advance with high precision. The image of this declined area will gradually acquire the whole spectrum and, at the same time, the height in the actual area will be known from the geometry of the declined area. The function of the dependence colour [R,G,B] =function (height) [mm] will be derived therefrom;
Testing the composition of the scanned surface. The image produced by the camera is composed of individual images that display all parts on the surface of the tested product. Dimensions in the x and y-axis correspond to the actual dimensions of the recorded item. The colour reflection of the item corresponds to its height above the surface.
Then, the software calculates (according to the function acquired during the calibration) the ascertained values of the colour components [R,G,B] of the individual pixels for the actual height (z-axis).

In the currently tested area, the software directly returns the values of the height (e.g. upper area of the condenser).

In other words, the inventive method for optically measuring the surface of a tested product, especially a PCB-product for reflow soldering paste inspection, using a device according to any of the aforementioned claims, comprises the following steps:

A beam of white light is emitted by said white light source that is rectified and collimated by said collimation unit into a parallel narrow beam passing trough said spectrometer unit, by which it is disintegrated into a colour spectrum. The reflection of said multichromatic beam on said product or components thereof is recorded by said camera. While moving said product in a scanning direction relative to said camera, an image is composed by said camera from individual images that displays all parts on the surface of said product and the image dimensions in a x and y-axis direction correspond to the actual dimensions of said product. At the same time, the hue values of the image, i.e. the values of colour components [R,G,B] of the individual pixels, are assigned to surface height values of said product.

According to another advantageous embodiment a hue height mapping of hue values of the colour spectrum to z surface height values can be calibrated by at least one gradual recording of a surface declination of a calibration body with a calibration angle β being known in advance with high precision and can be stored in a hue height map of a hue height mapping means. Preferably, the calibration body is a glass or ceramic board or disc or is made of an edged material.

By calibrating the measurement device by scanning a calibration body having a surface declined by a calibration angle β being known in advance, complicated calibration actions, such as high-precision mechanical adjustments of the device and complicated methods for determining surface height values, can be omitted. A complicated mechanical calibration being necessary for a resolution of 1 μm or less would lead to a highly expensive and complicated measuring action and is therefore not applicable for serial production methods. Surface height recognition is correlated with spectral hues of the light reflected from the surface of the product under testing. Since resolution of the camera pixels is limited, spectral components of the reflected light are usually mixed. The device can be calibrated by measuring a ramp function of a declined surface of a calibration body, being declined by a calibration angle β. Besides, a curved surface of the calibration body can also be used if the curvature function of the surface is known in advance. From scanning such a surface relief of a calibration body, a hue height map can be created, enabling the determination of a surface height from a measured hue value. For enhancing calibration quality of the device, a calibration routine can be repeated with different calibration angles and/or different calibration body widths, whereby an averaged hue height map can be calculated on the basis of the results of the different calibration routines. The different reflected spectral light components of the surface of the different calibration angles can be assigned to different z height values according to the bending function of the calibration body.

During a scanning process a direct evaluation of the height information can be extracted from the hue values of the image data produced by said camera (raw image data). Thus, a real-time z height profile of the surface of the tested camera can be produced, eliminating any measurement delays, whereby said real-time processing can be preferably achieved using a line-processing method.

During a calibration process an adaptation of the step width of the calibration body movement in x-axis scanning movement direction affects the calibration quality. Choosing a small step width or large step width determines the quality of calibration and z height measuring resolution, so that an SNR ratio (Signal Noise Ratio) can be optimized. For instance a surface ramp of a calibration body having the dimensions of 100 mm×150 mm×5 mm (length×scanning width×height) can be scanned with a scanning step width of 20 μm, which leads to a scanning data quantity of 5.000 pixels×7.500 pixels, which has to be stored as hue height map and which limits a z height resolution to 5000 height values. Reducing said step width to 1 μm leads to a z height accuracy resolution of 100.000 height values. A further modification of the surface of the calibration body, for instance following a predefined calibration surface function, can further enhance resolution accuracy. Using a precalibrated hue height map reduces data processing effort for further scanning processes, thus enhancing scanning time and reducing constraints in terms of the mechanical precision of the measurement device. In consequence, a serial production of measurement devices can be rendered less expensive and more easily feasible.

According to another advantageous embodiment the geometric position of said camera and said light source can be static for the whole duration of the scanning and/or a real-time hue height mapping can be performed during scanning using said hue height map.

According to another advantageous embodiment said camera can gradually record hue values line by line of a surface of said product while relatively moving said camera against said product in a scanning direction.

According to another advantageous embodiment said camera and said white light can be adjusted so that the beginning of said colour spectrum is mapped to zero height. Alternatively or additionally, the hue values recorded by said camera can be converted by means of a calibration function, preferably by a hue height map, into an actual surface height of the product or the components thereof.

According to another advantageous embodiment a 3D model of the product can be created based on measured x and y values of an image of said camera and z height values based on hue values of said image on the x and y axis.

According to another aspect of the present invention an application of an embodiment of an aforementioned device and an aforementioned method is proposed for measuring the dimensions of a product and/or for constructing a 3D model of said product, especially for measuring and inspecting the position and height of reflow soldering paste on a PCB product and/or for measuring the surface roughness of said product.

Surface roughness can be tested using a self-calibrated measurement device with high z height accuracy and a narrow width of the multichromatic light beam. As a calibration body a surface having a predefined value of surface roughness can be used instead of a calibration body having a declined surface by a calibration angle β. Thus, different calibration bodies with different surface roughness values have to be scanned in different z heights according to an embodiment of the measurement device for calibrating the device for surface roughness measurement. The extracted hue height map can be used for determining the surface roughness of surfaces in different z-height levels.

### Advantages of the Subject-Matter of the Invention

The main advantages of the present invention can be seen in the simplicity, resistance and integration of the inventive solution. The recording of the image together with the scanning of the item for geometric testing is carried out in one step. If it is not necessary to perform a test of the area for colour, it is possible to implement a 3D test directly onto the normal reading of the image which does not prolong the testing time. It is not necessary to recalculate the 3D model or to model it (as in the case of other systems), the height of the item is colour-recorded in the image and can be directly read. After incorporating the existing systems, no further actions requiring time are necessary, the invention has only minimum demands in terms of SW and it can be used as an additional module in already existing equipment.

The high variability and usability result from the easily adjustable scope of measurement by which it is possible to achieve the required measurement precision. The scope of measurement is set by the distance or by turning the optical prism when the width (and also the height) of the colour spectrum is changed so that the tested surface is lit. Therefore, it is possible to achieve the measurement precision for small items and components thereof (the measuring range is in tens of mm—e.g. electrotechnical components) in several micrometers.

The basis of this equipment are optical components, therefore, wearing or ageing are not encountered. The only component having a restricted service life is the source of light; however, there can be variations between hundreds to thousands hours of operation.

### BRIEF DESCRIPTION OF THE DRAWINGS

The present invention together with the mentioned and other objects and advantages may best be understood from the following detailed description of the embodiments, but is not restricted to these embodiments.

In the drawings:

FIG. 1—illustrates a first embodiment of a measurement device of the present invention for inspection of an electronic component alignment on a PCB;

FIG. 2—illustrates the first embodiment of a measurement device according to the present invention for inspection of a thin electronic component on a PCB corresponding to a red colour spectrum;

FIG. 3—illustrates the first embodiment of a measurement device according to the invention for inspection of a medium-sized electronic component on a PCB corresponding to a green colour spectrum;

FIG. 3—illustrates the first embodiment of a measurement device according to the present invention for inspection of a large electronic component on a PCB corresponding to a violet colour spectrum;

FIG. 5—illustrates an example of a colour spectrum hue height map with a scale range of 0-10 mm;

FIG. 6—illustrates another embodiment of a measurement device according to the present invention with an adjustable aperture means;

FIG. 7—illustrates another embodiment of a measurement device according to the present invention with an adjustable optical prism;

FIG. 8—illustrates another embodiment of a measurement device according to the present invention with an adjustable height of the optical prism;

FIG. 9—illustrates another embodiment of a measurement device according to the present invention;

FIG. 10—illustrates a light source and collimation unit configuration for an embodiment of a measurement device according to the present invention;

FIG. 11—illustrates another light source and collimation unit configuration for an embodiment of a measurement device according to the present invention;

FIG. 12—illustrates another light source and collimation unit configuration for an embodiment of a measurement device according the present invention.

FIG. 13—illustrates another light source and collimation unit configuration for an embodiment of a measurement device according to the present invention.

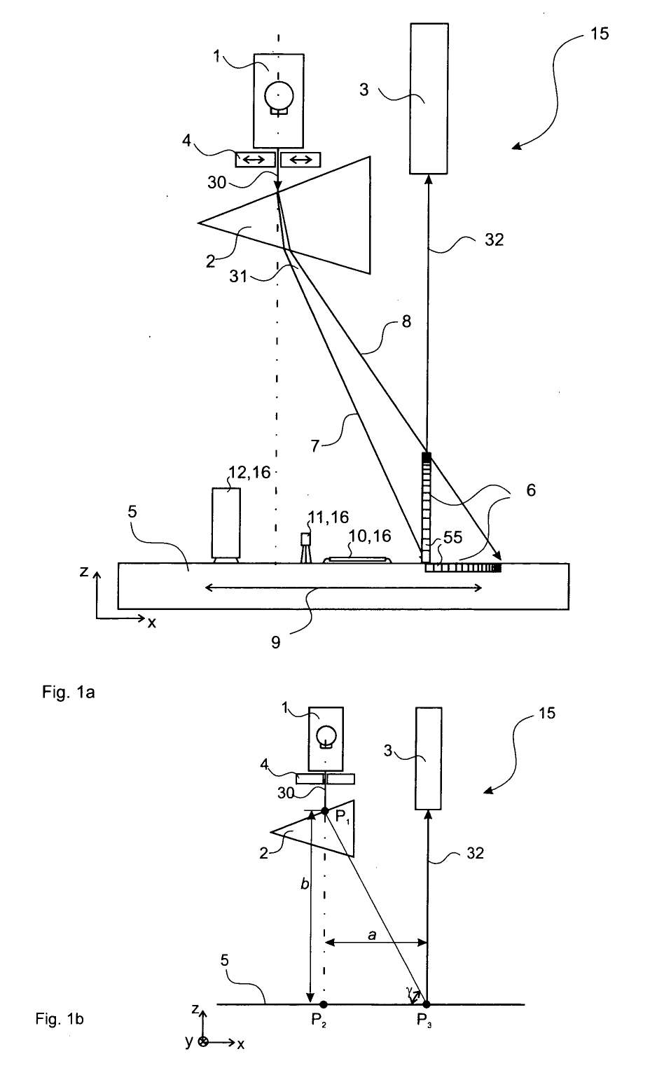

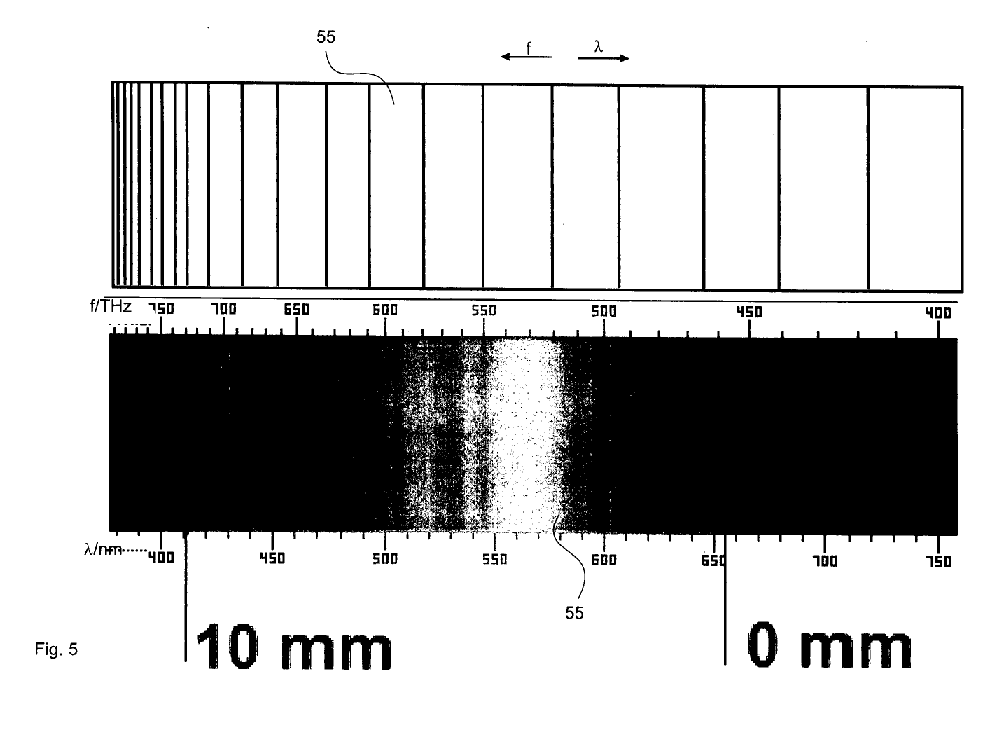

A first embodiment 15 for measurement of a tested product for optically creating a 3D model is shown in FIG. 1 and comprises a white light source 1 with a continuous spectrum of white light, an optical unit 4 for rectifying and collimating the white light into a collimated beam of white light 30, an optical prism 2 for splitting said collimated beam of white light 30 into a into a multichromatic beam 31 and a RGB-line scanning camera 3. The light of the light source 1 is collimated by the optical unit 4 into a parallel, narrow beam 30 which then passes through the optical prism 2 which acts as a spectrometer unit and mediates the disintegration of the light into a spectrum 31 (FIG. 5). The collimated light 30 which enters the prism 2 contains all colour elements. After passing through the optical prism 2 the white light 30 disintegrates into individual colours 31 according to the law of light refraction. The individual components are monochromatic and are reflected as a spectrum 55 via a monochromatic light beam 32. The width d 6 of the spectrum 55 directly influences the distance resolution in the z-axis. The line camera 3 (single row), which is preferably an RGB or at least a two colour camera 3 gradually scans a surface of the tested product 5 line by line by which it is moved in a x-axis scanning direction 9. The geometric position of the camera 3 and the reflected light 32 is the same during the whole period of scanning. The camera 3 and the reflected light 32 are adjusted to zero height (ground) so that the camera 3 displays the beginning 7 of the spectrum 55, i.e. the red colour. All non-zero heights are displayed in another colour as they are in the colour spectrum 55. For adjusting the width d 6 of the colour spectrum 55 the aperture size of the collimation unit 4 is adjustable, thus adjusting resolution quality and measurement range of z values. The tested product is a PCB 5 on which several electronic components 16, such as capacitors, transistors or ICs, are arranged. The measurement device 15 inspects a correct alignment of the electronic components 16.

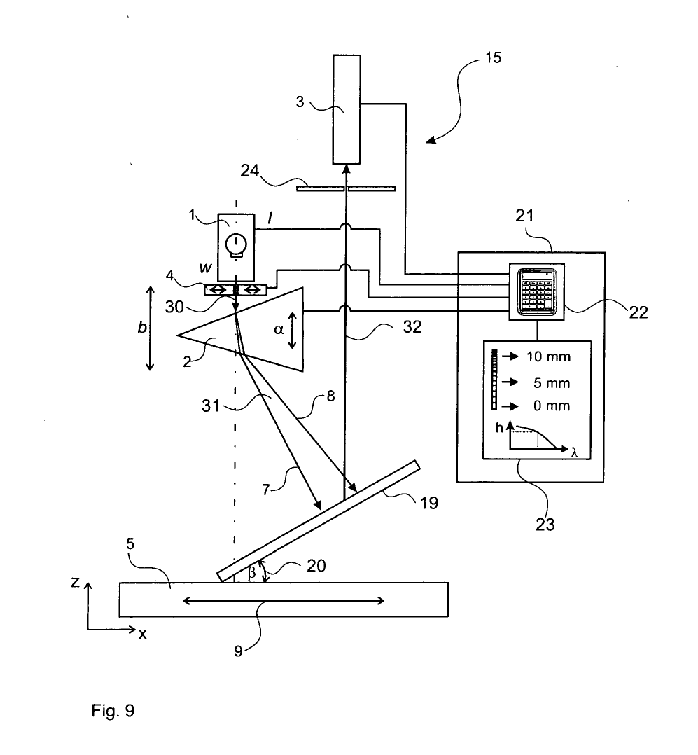

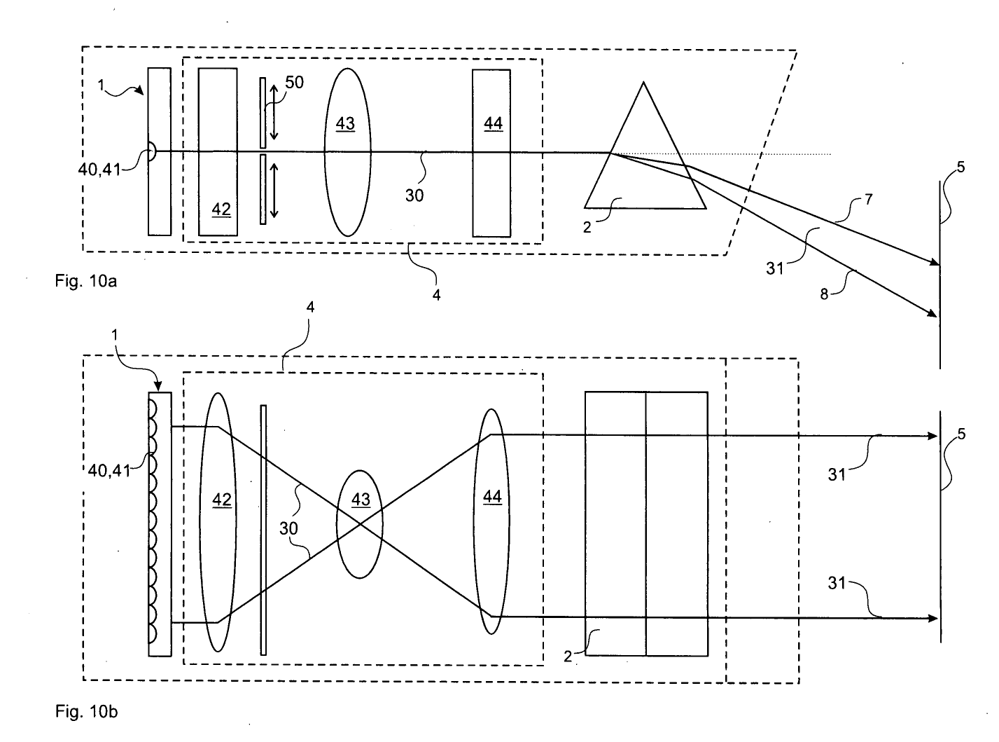

The manner of measurement of the tested product comprises several steps. The first step is the calibration of the colour spectrum for a distance conversion of the height. This is performed by scanning the declination angle β 20 of a surface area of a calibration body 19 where the angle of the declination β 20 is known in advance with high precision—see FIG. 9. The image of this declined area will gradually continue along the whole spectrum 55 and, at the same time, the height in the actual area will be known from the geometry of the declined height. The function of the dependence of the colour [R,G,B]=function(height) [mm/μm] is derived therefrom.

A further step is the testing of the composition of the scanned surface. The image produced by the camera 3 is composed of individual images that display all parts on the surface of the tested product 5. Dimensions in the x and y-axis correspond to the actual dimensions of the recorded product 5. The colour reflection 32 of the product 5 corresponds to its height above the surface. Then, a software calculates (according to the function acquired during the calibration) the ascertained values of the colour components [R,G,B] of the individual pixels for the actual height (z-axis). In the actual tested area, the software directly returns the values of the height (e.g. the upper area of the condenser).

FIG. 1b schematically illustrates a special arrangement of camera 3, white light source 1, collimation unit 4, spectrometer unit 2 and product under test 5. The white light source 1 emits white light which is collimated by the collimation unit 4 into a collimated white light beam 30. The collimated white light beam 30 is split into a multichromatic light beam 31 by the spectrometer unit 2, whereby the center of the multichromatic light beam 31 hits the surface of the product 5 at point P₃. At point P₃, a monochromatic light beam 32 is reflected perpendicular to a flat surface of the product under testing 5 into a lens of a camera 3. An optical axis of white light source 1 hits the surface of the product 5 at point P₂. Point P₁ defines an entrance point of the collimated light beam 30 into spectrometer unit 2, where the collimated white light beam 30 is refracted and expanded to a multichromatic light beam 31. Points P₁, P₂ and P₃ define a right angle triangle, whereby an angle γ defines the incidence angle with which the multichromatic light beam 31 hits the surface of the product. This angle γ depends on the height b of the spectrometer unit 2 above the surface of the product 5 (distance between Points P₁ and P₂) and a distance a between the optical axis of white light source 1 and camera 3 (distance between Points P₂ and P₃). By varying a and b, which means varying incident angle γ, a measurement resolution of surface values can be adjusted.

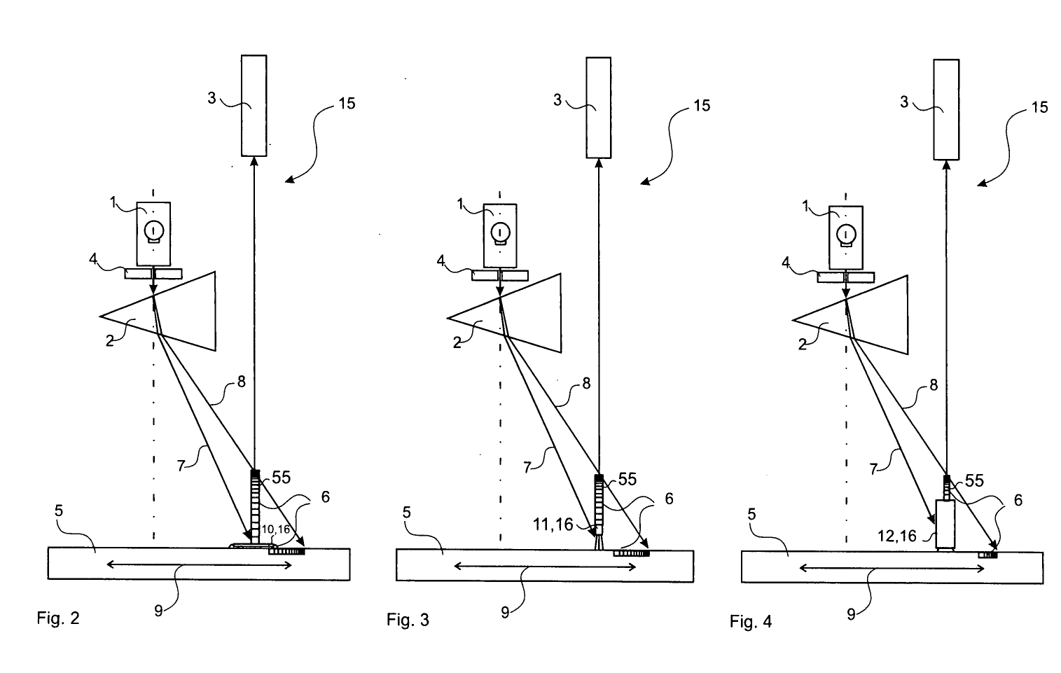

FIGS. 2, 3 and 4 schematically display a measurement of an electronic component 16 being mounted on a PCB board 5, while scanning the PCB board 5 in a scanning direction 9. FIG. 2 illustrates the reflection of a spectrum 55 on a small-sized electronic component 16, such as an IC (Integrated Circuit). The height of the electronic component 16 is small, so that a monochromatic light (red light) near the beginning of the colour spectrum 7 is reflected.

FIG. 3 illustrates a reflection of a medium-sized electronic component 16, e.g. a transistor, whereby a monochromatic colour from the middle of the spectrum, e.g. a green colour, is reflected and is detected by the camera 3. FIG. 4 illustrates a reflection of a multichromatic light beam of a large electronic component 16, such as a capacitor. A violet light, near the end of the colour spectrum 8 is reflected into camera 3. As such, from different hue values (red, green, violet) a height of an electronic component 16 mounted on a PCB 5 can easily be measured.

FIG. 5 displays a hue height map according to an embodiment of the present invention. The hue height map correlates a height range of 0 to 10 mm to a spectral light range between 460 to 740 THz (420 to 660 nm wavelength). Such a correlation between wavelength/frequency and metric dimensions can be extracted by a calibration routine according to an embodiment of the inventive method.

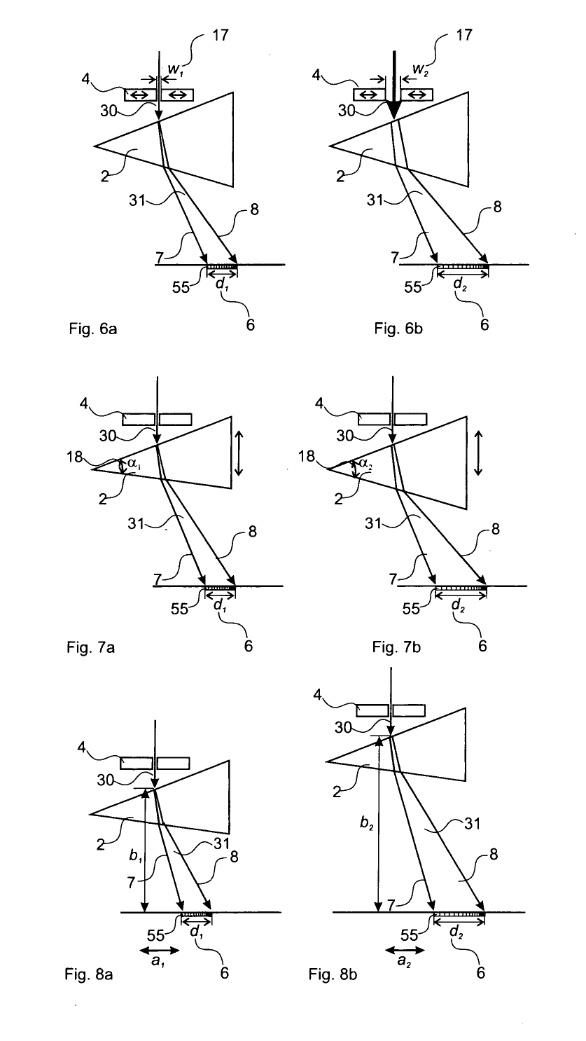

FIGS. 6, 7 and 8 illustrate several options of varying the width of colour spectrum 55 for controlling measurement resolution of an embodiment of the invention. FIG. 6 illustrates an arrangement wherein an aperture size of collimation unit 4 is varied between an aperture size w₁ to an aperture size w₂. In consequence, the width of the collimated white light beam 30 and the spreading angle of the multichromatic light beam 31 are varied and thus the width 6 of the spectrum 55 changes from length d 1 to length d 2.

FIG. 7 displays a similar effect by varying an opening angle a 18 of an optical prism 2. In FIG. 7a an optical prism has an opening angle α₁, resulting in a width d 16 of spectrometer 55. By varying the opening angle α₁ to a value α₂, a width 6of spectrometer 55 changes for d₁ to d₂. An optical prism having a variable opening angle α 18 can be provided by using a liquid optical prism, whereby the opening angle α 18 can be adjusted by different electrostatic potentials or by mechanical means or other techniques known from the state of the art.

FIG. 8 illustrates another embodiment of a measurement device 15, wherein a height b between a surface of a tested product 5 and a spectrometer unit 2 can be varied. By varying a distance b₁ to a distance b₂, the opening angle of multichromatic light beam 31 changes, thus resulting in a variation of width d 6 of spectrometer 55 from d₁ to d₂. According to the height variation from b₁ to b₂ of spectrometer 2 over the surface of a tested product 5, a distance a between the optical axis of white light source 1 and camera 3 should also be changed from a₁ to a₂, thus leaving incident angle γ constant.

FIG. 9 illustrates another embodiment of a measurement device 15, wherein a calibration routine is performed. On top of a product surface 5, a calibration body 19, e.g. a calibration board 19, is mounted having a declination angle β 20 being adjustable in relation to a horizontal surface of measured product 5. While moving the declined surface of calibration body 19 in a scanning direction 9, the white light source 1 produces a collimated beam of light 30, which is collimated by a collimation unit 4, and which is split into a multichromatic light beam 31 by spectrometer unit 2. Spectrometer unit 2 has a variable prism angle α and collimation unit 4 can change an aperture size w for adjusting the opening angle of the multichromatic light beam 31 to influence height measurement resolution accuracy. Due to movement of calibration body 19 in a scanning movement direction 9, different monochromatic light beams 32 are reflected towards camera 3, whereby camera 3 is equipped with a camera aperture unit 24 for eliminating parasitic scattered light. The camera 3 scans the light in correlation with the scanning movement 9 of calibration body 19 having a declined surface with calibration angle β 20 and transfers image data to a control unit 21. The control unit 21 comprises control means 22 which controls intensity/brightness of the white light source 1, aperture width w of collimation unit 4 and prism angle α 18 of spectrometer unit 2. Hue data received by camera 3 are stored in a hue-height map 20 of a hueheight mapping means 23, whereby different colours are associated with different z-height values being known form calibration angle β and the dimensions of calibration body 19.

FIG. 10 illustrates an ensemble of a white light source 1, a collimation unit 4 and an optical prism 2 for producing a beam of multichromatic light 31 having a beginning of a colour spectrum 7 (red light) and an end of a colour spectrum 8 (violet light) hitting a surface of a product 5 under testing. FIG. 10a displays a side view and FIG. 10b a top view of said ensemble. The white light source 1 comprises a stripe of LEDs 40 (Light Emitting Diode), whereby multiple microlenses 41 rectify the diffuse white light emitted by the LEDs 40 into a parallel light beam. The collimation unit 4 comprises a first lens 42, a second lens 43 and a fourth lens 44 as well as an aperture means 50 which can be a slit diaphragm. The opening width w of the slit diaphragm 50 is variable such that the width of the collimated white light beam 30 can be adjusted. The collimation unit 4 converts the white light beam emitted by the white light source 1 into a collimated white light beam 30 having parallel beams of white light of all different colour values. The optical prism 2 divides the collimated white light beam 30 into a multichromatic beam 31 of a spectrum 55 having an opening width b.

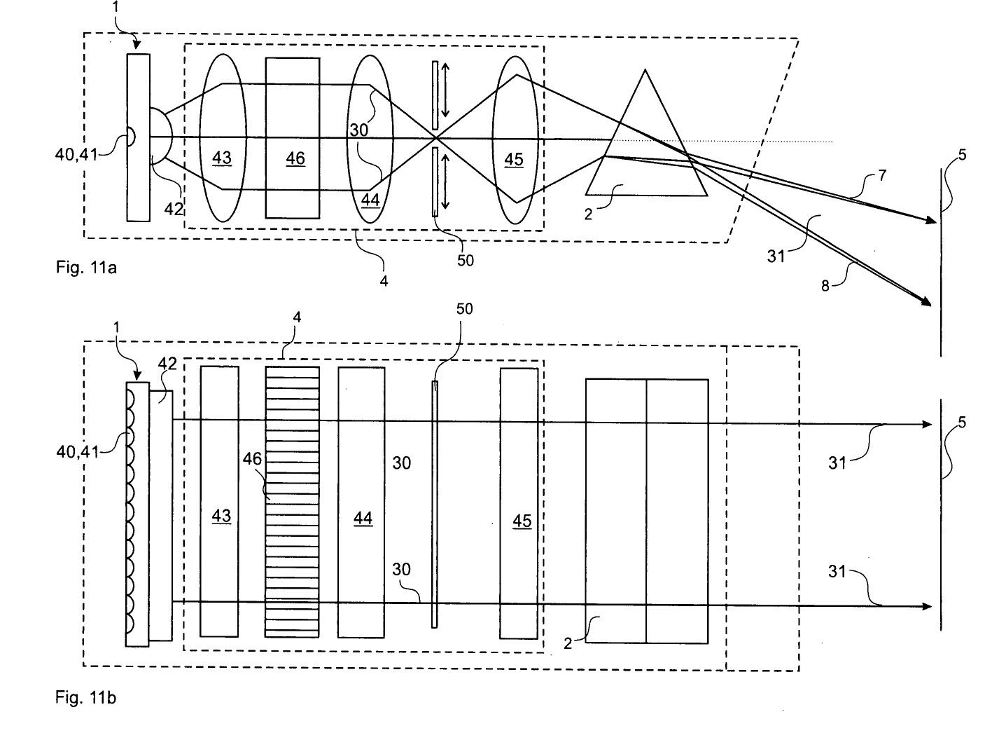

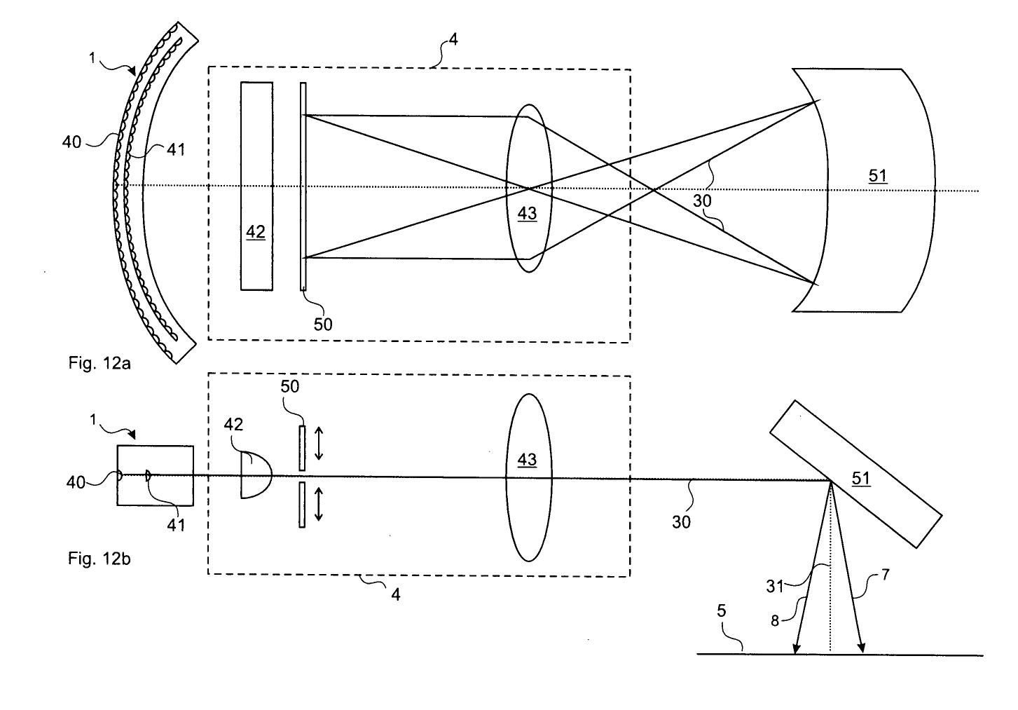

FIG. 11 illustrates another embodiment of a white light source 1, a collimation unit 4 and an optical prism 2 for forming a multichromatic beam of light 31. FIG. 11a displays a side view and FIG. 11b a top view of said ensemble. The white light source 1 comprises an LED stripe 40 equipped with microlenses 41 and a first lens 42. The collimation unit 4 comprises multiple lenses 43, 44 and 45 for suppressing parallax effects and further comprises an aperture unit 50 having a variable opening width and a collimation grid 46 for collimating the diffuse white light beam emitted by white light source 1. The collimated white light beam 30 is converted into an rainbow-beam 31 of multichromatic colours by a prism 2.

FIG. 12 illustrates another embodiment of a white light source 1, a collimation unit 4 and a spectrometer unit, wherein the white light source 1 comprises a bended LED stripe comprising a banded stripe of microlenses 41 for pre-rectifying emitted white LED light. FIG. 12a displays a top view and FIG. 12b a side view of said ensemble. The light of the bended light source 1 enters a collimation unit 4 and is rectified by a first cylinder lens 42, and falls through an aperture unit 50 having an adjustable opening width and finally focussed by an elliptical second lens 43 before leaving said collomination unit 4. The collimated beam 30 of white light is then reflected and converted into a multichromatic beam of light 31 by an optical diffraction grading 51. A surface of a tested product 5 is arranged in parallel to the optical axis of collimated white light beam 30 beneath said optical diffraction grading 51.

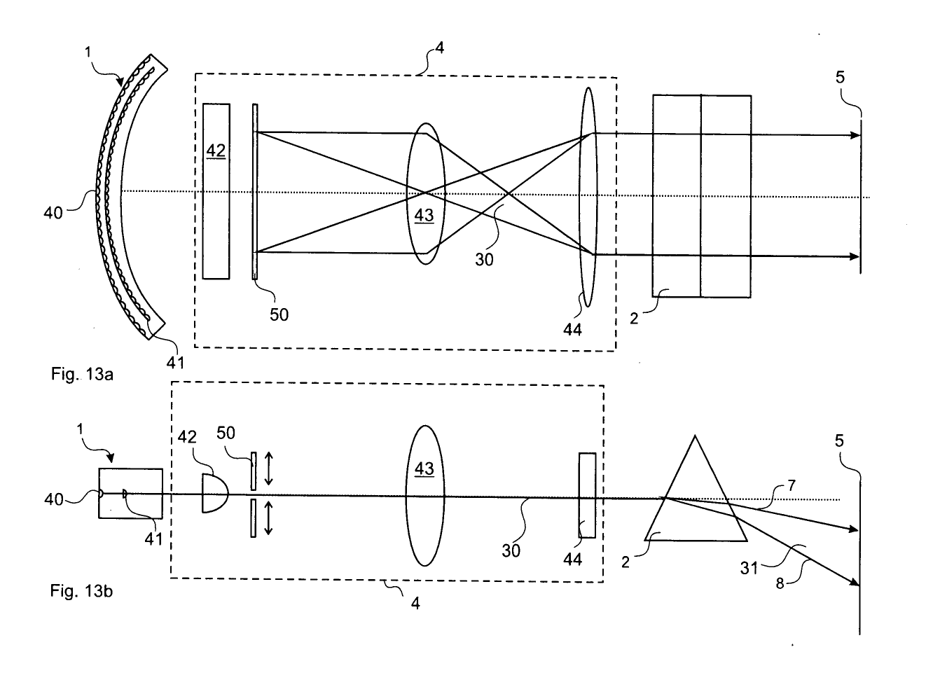

Finally, FIG. 13 illustrates a similar embodiment of a white light source 1, a collimation unit 4 and a spectrometer unit, whereby the spectrometer unit is an optical prism 2. FIG. 13a displays a top view and FIG. 13b a side view of said ensemble. The white light source 1 comprises a bended stripe of LEDs 40 equipped with a bended stripe of microlenses 41 for pre-rectifying an beam of white light 30 which is collimated by a collimation unit 4. The collimation unit 4 comprises a cylinder lens 42, an aperture means 50, which is a slit diaphragm having a variable opening width, and an elliptical lens 43. Finally, the collimation unit 4 comprises a third lens 44 at the optical end thereof and said collimated beam of light 30 enters an optical prism 2 for being diffracted into a beam of multichromatic light 31 hitting the surface of a product under testing 5.

Another embodiment of the device can be used for testing electronic boards containing electronic components:
The tester 15 is calibrated so that zero height is defined on the surface of the mounted (master) board 5, so that after scanning, the board (ground) will be displayed in a dark red colour (beginning 7 of the spectrum). The measuring range is selected according to the highest measured part 12 (violet).
In the testing plant the position is defined along with the height and the tolerance of the measured product 5 (of the board).
After passing the board through the line scanning camera 3 the individual components thereof are displayed in colour depending on their height.
The software, using the calibration function, transfers colour shades to the values of the height given in millimetres.
In the tested areas the actual height of the component is evaluated and with respect to the specified tolerance the output is in the form of information indicative of whether the tested product 5, the board as a whole (or its individual components) are defective or not.

Another embodiment of the device can be used for testing board surfaces or surfaces of solar cell products:
The tester 15 is calibrated so that the surface in a normal acceptable status will be displayed after scanning in the colour which is usually approximately located in the middle of the spectrum (e.g. green).
The measuring range is selected, i.e. the maximum (largest) and minimum (smallest) deviations which can occur on the tested board (bending of the board, surface defects, cracks, abrasions, sediments, etc.). The smallest deviation will be displayed in red colour and the largest will be displayed violet colour.
The whole surface of the calibration body can be defined as a tested area and the deviation tolerance of deviation is selected.
The board can be scanned by means of a line scanning camera 3.
Using the calibration function, the software can convert the colour shades into the values of the height given in millimetres or μ-meters.
It is evaluated whether any area has larger deviations than predetermined by the permitted tolerance. The output can be information representative of the aspect of whether the tested product 5 (board) is defective or not.

### INDUSTRIAL APPLICABILITY

The technical solution to the invention can be particularly used for approximate or target inspection of the geometry and measurement of the distance of individual products or components thereof, particularly where there is the necessity to optically measure the distance between the sensor and the tested part, i.e. in the direction in which the change is not reflected on the image in the normal status.

### Reference Signs:

1—white light source
2—optical prism
3—camera
4—collimation unit
5—measured product (e.g. PCB)
6—width of the colour spectrum
7—beginning of the colour spectrum
8—end of the colour spectrum
9—scanning movement direction
10—component with the height corresponding to a red colour of the white light spectrum
11—component with the height corresponding to a green colour of the white light spectrum
12—component with the height corresponding to a violet colour of the white light spectrum
15—measurement device
16—electronic component
17—aperture width of collimation unit
18—variable prism angle a
19—calibration body
20—calibration angle 13
21—control unit
22—control means
23—hue height mapping means
24—camera aperture unit
30—collimated white light beam
31—multichromatic light beam
32—reflected monochromatic light beam
40—LED stripe
41—microlens
42—first lens
43—second lens
44—third lens
45—fourth lens
46—collimation grid
50—aperture means
51—optical diffraction grading
55—colour spectrum

1. A device for optically measuring the surface of a tested product comprising:
at least one white light source to emit a beam of white light,
at least one collimator to collimate said beam of white light,
at least one spectrometer to split said beam of white light into a beam of multichromatic light being directed onto said tested product under a set incident angle γ, and
at least one camera to record a reflected beam of monochromatic light of said tested product such that a z-axis surface height information of said tested product can be extracted from a hue value of said reflected beam of monochromatic light while relatively moving said tested product in a x-axis scanning direction,
wherein said white light source includes an LED stripe, which is adapted for producing a white light stripbeam,
wherein at least one microlens is optically coupled to at least one LED for prerectification of said beam of white light, and
wherein said collimation unit is adapted to collimate said white light beam in 360° with a collimation quality of 2° or less and to form a white light stripbeam being perpendicular to said scanning direction, and comprises at least one lens and at least one aperture.

2. The device according to claim 1, wherein said white light source has a continuous spectrum and/or the frequency-bandwidth of the spectrum is variable, by dimming of said light source or by selectively switching two or more light sources on or off in parallel.

3. The device according to claim 2, wherein multiple LEDs of an LED stripe can be selectively switched either on or off for enhancing intensity and/or length of white light beam in a y-axis direction perpendicular to said scanning direction.

4. The device according to claim 3, further comprising a scanning transport to transport said tested product or said light source, a spectrometer unit, a collimation unit and a camera in a scanning direction.

5. The device according to claim 4, wherein said camera includes is a line scanning camera, to receive a beam of monochromatic light reflected from said beam of multichromatic light by said tested product, and/or said camera is includes a digital camera with at least 8 Bit hue resolution, and/or said camera comprises two or more line scanning rows, each row comprising a color filter to filter a hue sensitivity, and/or said camera comprises at least one grey or black/white scanning row for enhancing scanning quality, or said camera includes is an area scanning camera, wherein single or multiple scanning rows of said scanning area can be extracted for hue height information processing.

6. The device according to claim 5, comprising at least two or more cameras arranged in a y-axis direction perpendicular to said x scanning direction for parallel scanning, thus enhancing scanning width of said product and/or said cameras being stereometrically arranged for 3D-scanning of said product for reducing shadowing and illumination effects.

7. The device according to claim 6, further comprising a controller in electrical connection with at least said camera, said controller comprises a control device and hue height mapper to at least control said camera and to map hue values of an image captured by said camera to a surface height information of said product.

8. The device according to claim 7, further comprising an adjuster controllable by said control device of said controller to adjust the color spectrum width d of said multichromatic beam, particularly for adjusting an armature width w of said collimator, and/or to adjust a beam splitting height b, distance a between optical line of source and camera or said prism angle α of said spectrometer to adjust height measuring sensitivity.

9. A method for optically surface measuring of a tested product, especially a PCB-product for reflow soldering paste inspection using a device according to any of the aforementioned claims, wherein a beam of white light is emitted by said white light source and is rectified and collimated by said collimator into a parallel narrow beam passing through said spectrometer, by which it is disintegrated into a color spectrum whose reflection on said product or components thereof is recorded by said camera while moving said product in a scanning direction relative to said camera, so that an image composed by said camera from individual images displays all parts on the surface of said product and the image dimensions in x and y-axis direction correspond to the actual dimensions of said product, and, at the same time, the hue values of the image.

10. The method according to claim 9, wherein a hue height mapping of hue values of the color spectrum to z surface height values is calibrated by at least one gradual recording of a surface declination of a calibration body with a calibration angle β being known in advance with high precision and storing a hue height map in a hue height mapper.

11. The method according to claim 9, wherein the geometric position of said camera and said light source is static during the whole time of scanning and/or a real-time hue height mapping is performed during scanning using said hue height map.

12. The method according to claim 9, wherein said camera gradually records hue values line by line of a surface of said product while relatively moving said camera against said product in a scanning direction.

13. The method according to claim 9, wherein said camera and said white light are adjusted so that the beginning of said colour color spectrum is mapped to zero height and/or the hue values recorded by said camera are converted by a calibration function, preferably by a hue height map to an actual surface height of the product or components thereof.

14. The method according to claim 9, wherein a 3D model of the product is created using measured x and y values of an image of said camera and a z height value using hue values of said image on the x and y-axis.

15. The method according to claim 9 applied for measuring the dimensions of a product, especially for measuring and inspecting the position and height of reflow soldering paste on a PCB or solar cell product and/or for measuring the surface roughness of said product.

16. The device according to claim 1, wherein multiple LEDs of an LED stripe can be selectively switched either on or off for enhancing intensity and/or length of white light beam in a y-axis direction perpendicular to said scanning direction.

17. The device according to claim 1, further comprising a scanning transport to transport said tested product or said light source, a spectrometer unit, a collimation unit and a camera in a scanning direction.

18. The device according to claim 1, wherein said camera includes a line scanning camera with a camera aperture unit and/or a parallax lens unit to reduce parallax effects, and/or a cylinder lens or round lens unit, the line scanning camera to receive a beam of monochromatic light reflected from said beam of multichromatic light by said tested product, and/or said camera includes a digital camera with at least one of an 8 Bit hue resolution, an adjustable 10, 12 Bit or higher hue resolution, and/or said camera comprises two or more line scanning rows, each row comprising a color filter to filter to increase a hue sensitivity, and/or said camera comprises at least one grey or black/white scanning row for enhancing scanning quality, or said camera includes an area scanning camera, wherein single or multiple scanning rows of said scanning area can be extracted for hue height information processing.

19. A method for optically surface measuring of a tested product in a PCB-product for reflow soldering paste inspection, comprising:
emitting a beam of white light from a white light source;
rectifying and collimating the white light source into a parallel narrow beam passing through a spectrometer, by which the light is disintegrated into a color spectrum recording, by a camera, a reflection on said product or components thereof while moving said product in a scanning direction relative to said camera, so that an image composed by said camera from individual images displays all parts on the surface of said product and the image dimensions in x and y-axis direction correspond to the actual dimensions of said product, and, at the same time, the hue values of the image including values of color part of individual pixels being assigned to surface height values of said product.
